(19) United States
(12) Patent Application Publication
(10) Pub. No.: US 2006/0261132 A1
(43) Pub. Date: Nov. 23, 2006

(54) Low range bonding tool

(76) Inventor: Steven F. Reiber, Rocklin, CA (US)

Correspondence Address: CARR & FERRELL LLP, 2200 GENG ROAD, PALO ALTO, CA, 94303, US

(21) Appl. No.: 11/406,504

(22) Filed: Apr. 17, 2006

Related U.S. Application Data
(63) Continuation-in-part of application No. 10/943,151, filed on Sep. 15, 2004, now Pat. No. 7,032,802.
(63) Continuation-in-part of application No. 10/650,169, filed on Aug. 27, 2003, now Pat. No. 6,935,548.
Application No. 10/650,169 is a continuation of application No. 10/036,579, filed on Dec. 31, 2001, now Pat. No. 6,651,864.
Application No. 10/650,169 is a continuation-in-part of application No. 09/514,454, filed on Feb. 25, 2000, now Pat. No. 6,354,479.
(60) Provisional application No. 60/503,267, filed on Sep. 15, 2003.
(60) Provisional application No. 60/288,203, filed on May 1, 2001.
(60) Provisional application No. 60/121,694, filed on Feb. 25, 1999.
(60) Provisional application No. 60/671,937, filed on Apr. 15, 2005.

(51) Int. Cl. A47J 36/02

(52) U.S. Cl. 228/101

(57) ABSTRACT

Bonding tool tips and wedge tools for bonding electrical connections are disclosed herein. The tool tips have 10² to 10⁵ ohms of resistance and the wedge bonding tools have a range of 10¹² to 10¹⁹ ohms of resistance. A resistive material coating the tool tip and wedge tool has a resistance low enough to discharge a voltage in a device being bonded and high enough to avoid current flow large enough to damage the device being bonded.

### CROSS-REFERENCE TO RELATED APPLICATIONS

This application is a continuation-in-part and claims the priority benefit of U.S. patent application Ser. No. 10/943,151 filed Sep. 15, 2004 and entitled “Bonding Tool with Resistance,” which claims the priority benefit of U.S. provisional patent application No. 60/503,267 filed Sep. 15, 2003 and entitled “Bonding Tool” and is also a continuation-in-part and claims the priority benefit of U.S. patent application Ser. No. 10/650,169 filed Aug. 27, 2003 and entitled “Dissipative Ceramic Bonding Tool Tip,” which is a continuation of U.S. patent application Ser. No. 10/036,579 filed Dec. 31, 2001 and entitled “Dissipative Ceramic Bonding Tool Tip,” which claims the priority benefit of U.S. provisional patent application No. 60/288,203 filed May 1, 2001 and is also a continuation-in-part and claims the priority benefit of U.S. patent application Ser. No. 09/514,454 filed Feb. 25, 2000 and entitled “Dissipative Ceramic Bonding Tool Tip,” which claims the priority benefit of provisional patent application No. 60/121,694 filed Feb. 25, 1999; this application also claims the priority benefit of U.S. provisional patent application No. 60/671,937 filed Apr. 15, 2005 and entitled “Low Range Bonding Tool.”

This application is related to U.S. patent application Ser. No. 10/942,311 filed Sep. 15, 2004 entitled “Flip Chip Bonding Tool Tip.”

The disclosures of all of these applications are incorporated herein by reference.

### BACKGROUND OF THE INVENTION

1. Field of the Invention

This invention relates to bonding tool tips for bonding electrical connections and, more particularly, to bonding tool tips with 10² to 10⁵ ohms of resistance and wedge bonding tools with a range of 10¹² to 10¹⁹ ohms of resistance.

2. Description of the Related Art

Integrated circuits are typically attached to a lead frame and individual leads are connected to individual bond pads on the integrated circuit with wire. The wire is fed through a tubular bonding tool tip having a bonding pad at the output end. These tips are commonly called capillary tips. An electrical discharge at the bonding tool tip supplied by a separate EFO (electronic flame off) device melts a bit of the wire thereby forming a bonding ball.

Other bonding tools do not have the center tube, but have a feedhole or other feature for feeding the wire as needed. Some bonding tips have no such wire arrangement as the wire is supplied at the location where the wire is insulated and bonded to a magnetic head and then to a flexible wire circuit. Such is the case in magnetic disk recording devices. The capillaries are typically made out of zirconium toughened alumina (ZTA) while wedge bonding tools, flip chip bonding tools, and ball placement tools are made out of an electrical discharge machine-able (EDM) material like tungsten carbide (WC).

When the bonding tip is on the integrated circuit die side of a wire connection, the wire will form a ball on the end of the wire, as above, before reaching the next die bonding pad. The ball then makes intimate contact with a film formed on the die pad on the integrated circuit. The bonding tip is then moved from the integrated circuit die pad, with gold wire being fed out as the tool is moved, onto the bond pad on the lead frame, and then scrubbed laterally by an ultrasonic transducer. Pressure from the bonding tool tip, the transducer, and capillary action, ‘flows’ the wire onto the bonding pad where molecular bonds produce a reliable electrical and mechanical connection.

During wedge bonding, a clamped wire is brought in contact with the bond pad. Ultrasonic energy is then applied to the wire for a specific duration while being held down by a specific amount of force, forming a first wedge bond between the wire and the bond pad. The wire is then run to a corresponding lead finger, against which it is again pressed. A second bond is again formed by applying ultrasonic energy to the wire. The wire is then broken off by clamping and movement of the wire.

Bonding tool tips and wedge bonding tools must be sufficiently hard to prevent deformation under pressure and mechanically durable so that many bonds can be made before replacement. Prior art bonding tool tips may be made of ZTA, which is an insulator, but provides the wear ability to form thousands of bonding connections. Wedge bonding tools may be made from WC that is conductive so that it may be subjected to EDM.

Bonding tool tips must also be electrically designed to produce a reliable electrical contact yet prevent electrostatic discharge damage to the part being bonded. Certain prior art devices have a one-or-more volt emission when the tip makes bonding contact. This could present a problem as a one-volt static discharge could generate a 20 milliamp current to flow, which could cause the integrated circuit to fail due to this unwanted current.

### SUMMARY OF THE INVENTION

Bonding tool tips with 10² to 10⁵ ohms of resistance and wedge bonding tools with a range of 10¹² to 10¹⁹ ohms of resistance for bonding electrical connections to bonding pads on electrical devices are disclosed.

In accordance with an embodiment of the present invention, the range of resistance needs to be lower as the electrostatic discharge (ESD) voltages get smaller to avoid damaging delicate electronic devices by any electrostatic discharge. A bonding tool tip or wedge bonding tool must conduct electricity at a rate sufficient to prevent charge buildup and stop all transient currents, but not at so high a rate as to trap voltage in the device being bonded. It is desirable for the bonding tool tip or wedge bonding tool to discharge as quickly as possible but to have less than 5 milliamps of currents. The tool tip or wedge bonding tool should also discharge or block any sudden surges of current that could damage the part being bonded.

In an exemplary embodiment, a resistance in the tool tip assembly ranges from 500 to 99,999 ohms. In an exemplary wedge bonding tool, resistance ranges from 10¹² to 10¹⁹ ohms to stop the passing of all large currents. The tools must also have specific mechanical properties to function satisfactorily.

Various embodiments of the aforementioned bonding tools with desired electrical conduction may be constructed through at least three different processes.

In a first embodiment, tools are made from a uniform extrinsic semi-conducting material that has dopant atoms in the appropriate concentration and valence states to produce sufficient mobile charge carrier densities—unbound electrons or holes—that will result in electrical conduction in the desired range; for example, silicon carbide.

In a second embodiment, tools maybe made by forming a thin layer of a highly doped semiconductor on an insulating core. In this instance, the core provides mechanical stiffness while the semi-conductor surface layer provides abrasion resistance and provides a charge carrier path from the tip to mount that will permit dissipation of electrostatic charge at an acceptable rate; for example, a diamond tip wedge that is ion implanted with boron.

A third embodiment provides for tools to be made by forming a lightly doped semi-conductor layer on a conducting core. The conducting core provides the mechanical stiffness and the semi-conductor layer provides abrasion resistance and provides a charge carrier path from the tip to conducting core, which is electrically connected to the mount. The doping level is chosen to produce conductivity through the layer, which will permit dissipation of electrostatic charge at an acceptable rate; for example, cobalt bonded tungsten carbide coated with titanium nitride carbide.

### BRIEF DESCRIPTION OF THE DRAWINGS

FIG. 1 is a cross-section view of an exemplary capillary bonding tool tip;

FIG. 2 is a cross-sectional view of the operating end or tip of a bonding tool like that illustrated in FIG. 1;

FIG. 3 is a cross-sectional view of a bottle-neck capillary bonding tool tip;

FIG. 4 is an isometric view of a wedge bonding tool tip;

FIGS. 5a and 5b are top and front views, respectively, of the wedge design of the bonding tool tip as shown in FIG. 4;

FIG. 6 is an isometric view of a typical commercial apparatus utilized in the wire bonding of a semiconductor integrated circuit chip or other apparatus;

FIG. 7 is a cross-section of an embodiment of the bonding tool tip of FIG. 7 and having two layers;

FIG. 8 is a cross section of an embodiment of the bottle-neck capillary tool tip of FIG. 3 and having two layers; and

FIG. 9 is a cross section of an embodiment of the wedge-bonding design of FIG. 5 and having two layers.

### DETAILED DESCRIPTION OF THE INVENTION

FIG. 1 illustrates an exemplary capillary bonding tool 10. In one embodiment, the bonding tool 10 is about one-half inch (12-13 mm) long and about one-sixteenth inch (1.6 mm) in diameter. A bonding tool tip 12 is, in exemplary embodiments, 3 to 10 mils (0.08 to 0.25 mm) long. Running a length of the bonding tool 10 but not viewable in FIG. 1, is a tube hole, which will accommodate a continuously fed length of gold wire (not shown).

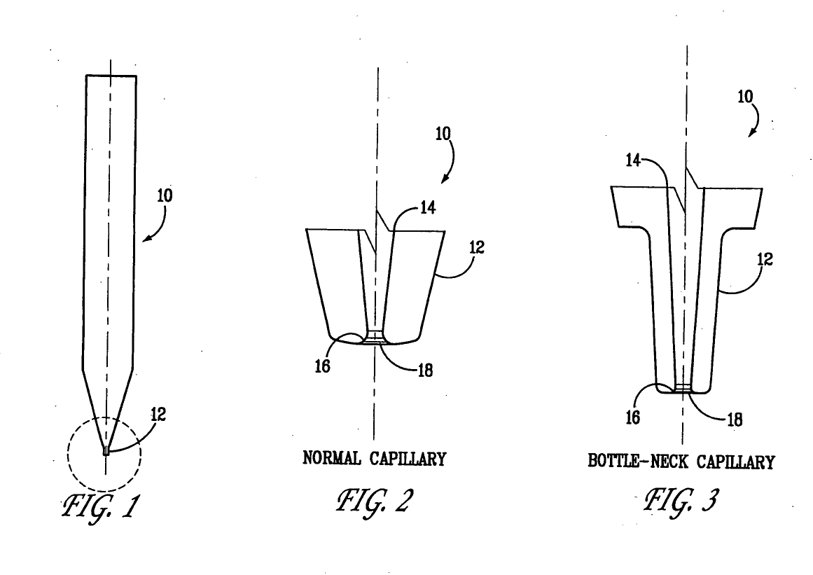

FIG. 2 is an enlarged, cross-sectional view of the capillary bonding tool 10 of FIG. 1. Only that portion of the bonding tool 10 shown within the dotted circle in FIG. 1 is shown in FIG. 2. Tool tip 12 has the tube hole 14, which may run the entire length of bonding tool 10. Exit hole 18 is where the wire (not shown) exits tool tip 12. If a ball is formed on the wire, the ball will be seen immediately adjacent the exit hole 18. A chamfer surface 16, at the exit hole 18, accommodates the ball that has been formed at the end of the gold wire. The chamfer surface 16 is provided to allow for smoother looping of the wire as the bonding tool 10 is moved from the bonding pad on an integrated circuit to the bonding pad (not shown) on a lead frame of an integrated circuit assembly. A wedge tool for disk drive bonding is used to capture the insulated wire, lay it on the head, and ultrasonically bond it there.

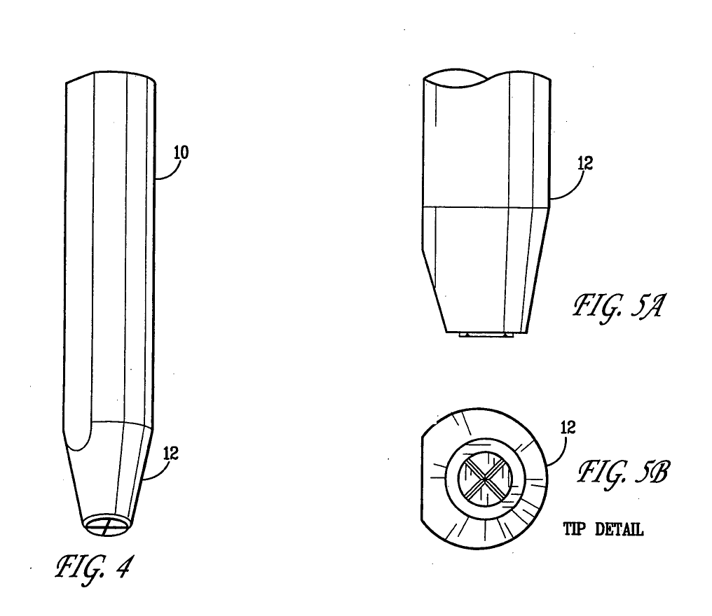

FIG. 3 is an alternative embodiment of a bonding tool 10 showing similar features: tube hole 14, chamfer surface 16, and exit hole 18. This bonding tool tip 12, referred to as a bottle-neck capillary tip, is provided for narrower bond situations where the bonding pitch—the distance between the centers of the bonding pads—is smaller. This design is necessitated, in part, by the dimensions of an integrated circuit getting smaller or the number of circuits on a chip increasing, but the die area remaining more or less constant.

FIG. 4 shows another type of bonding tool 10. The embodiment of FIG. 4 is used with an integrated circuit die mounted on a lead frame (not shown). In this instance, wires from an integrated circuit are not connected from a die to connections directly in an integrated circuit package, but from an integrated circuit die to a lead frame.

As the composition of the lead frame is different than the composition of an integrated circuit package, the tip 12 of the bonding tool 10 must be different to accommodate the different physical attributes of the integrated circuit lead frame as seen in FIGS. 5a and 5b, which are magnified views of FIG. 4 offering more explicit tip detail.

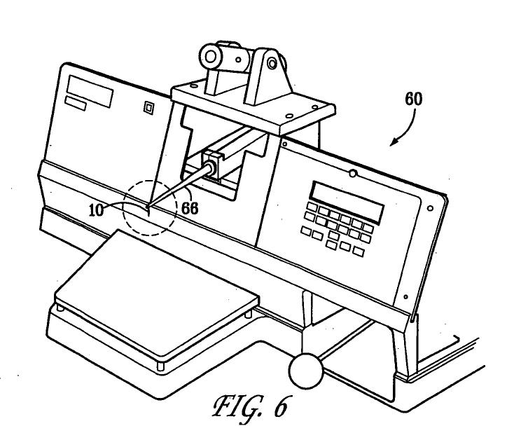

FIG. 6 illustrates a typical wire bonding machine 60 for use in bonding wire leads in magnetic disk drive units. Shown within the dotted circle is the bonding tool 10. The bonding tool 10 is mounted to arm 66, which is moved in the desired directions by the apparatus of wire bonding machine 60. Such a machine is available as Model 7400 from the West-Bond Inc. of Anaheim, Calif.

Typical bonding tips available on the market today are made of an insulator of alumina (Al₂O₃), sometimes termed aluminum oxide, or WC, which has less than 30 ohms of resistance. These very hard compounds have been used on commercial machines with success as it provides a reasonably long life in use as a wire bonding tool. To ensure that the capillary is an insulator, no conductive binders are used in these bonding tips and the wedge tools are made from conductive materials. As stated previously, however, the problem is that an electrostatic discharge from the bonding tool 10 making contact with the bonding pad of the desired circuit can damage the very circuit it is wiring.

In accordance with the principles of the present invention, to avoid damaging delicate electronic devices by this electrostatic discharge, the bonding tool tip 12 must conduct electricity at a rate sufficient to prevent charge buildup and to dissipate the charge in the device, if any, but not at so high a rate as to overload the device being bonded.

It has been determined that as the voltages become lower during the manufacturing process the range can become lower to. The resistance should be low enough so that the material can dissipate the small voltages very quickly yet keep the current below 5 milliamp and high enough so that it is not a conductor, allowing a transient current to flow through the tool to the device.

It has been determined that as voltages become lower during the manufacturing process, the resistance range can become lower too. The resistance should be low enough so that material can dissipate small voltages very quickly yet keep the current below 5 milliamps. The resistance should also be high enough so that if it is not a conductor, a transient current can flow through the tool to the device.

In an exemplary embodiment, resistance in the tip assembly should range from 500 to 99,000 ohms of resistance. For example, for today's magnetic recording heads, 5 milliamps of current will result in damage. As such, it is preferred that no more than 2 to 3 milliamps of current be allowed to pass through the tip 12 of the bonding tool 10 to the recording head. In some wedge bonding applications, there is a need to stop all currents from passing to the machine or to the part being bonded.

The bonding tool 10 also has specific mechanical properties to function satisfactorily. High stiffness and high abrasion resistance requirements have limited possible materials, for example, to ceramics (electrical non-conductors) or metal, such as tungsten carbide (electrical conductor). The exemplary tool tip 12 should have a Rockwell hardness of about 85 or above, preferably of about 89 or above. Additionally, the tool tip 12 needs to be able to last for at least 30,000 bonding cycles.

In the present invention, bonding tool tips with the desired electrical conduction can be made with three different configurations. First, the tools can be made from a uniform extrinsic semi-conducting material which has dopant atoms in appropriate concentration and valence states to produce sufficient mobile charge carrier densities—unbound electrons or holes—which will result in electrical conduction in a desired range. Polycrystalline silicon carbide uniformly doped with boron is an example of such a uniform extrinsic semi-conducting material.

Second, the tools can be made by forming a thin layer of a highly doped semi-conductor on an insulating core. In this instance, the core provides mechanical stiffness while the semi-conductor surface layer provides abrasion resistance and a charge carrier path from tip to mount that will permit dissipation of electrostatic charge at an acceptable rate. A diamond tip wedge that is ion implanted with boron is an example of such a thin layered tool.

Third, the tools can be made by forming a lightly doped semi-conductor layer on a conducting core. The conducting core provides mechanical stiffness while the semi-conductor layer provides abrasion resistance and a charge carrier path from tip to conducting core, which is electrically connected to the mount. A doping level is chosen to produce conductivity through the layer which will permit dissipation of electrostatic charge at an acceptable rate. A cobalt-bonded tungsten carbide coated with titanium nitride carbide is an example of such a lightly doped tool.

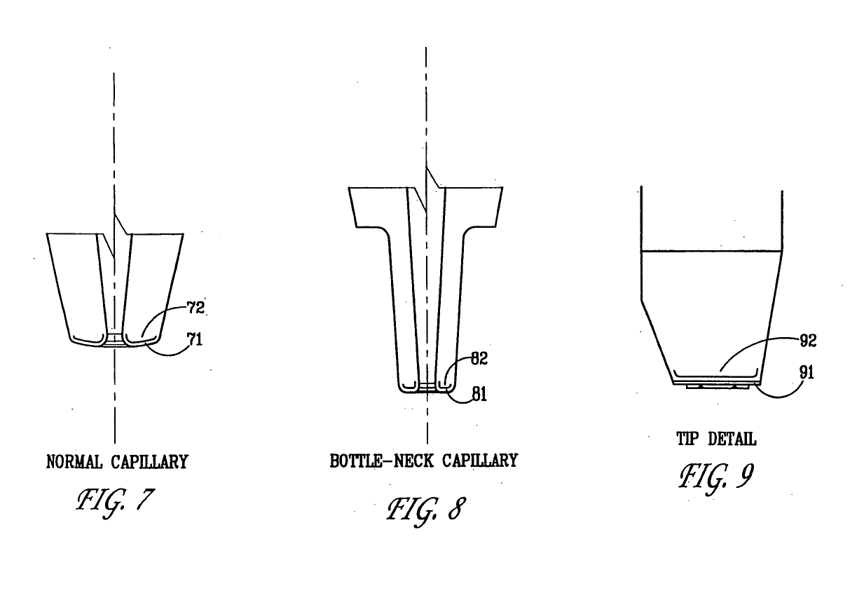

FIGS. 7, 8 and 9 illustrate a two-layered structure of capillary, bottle-neck, and wedge designs. These structures are not intended to be specific to the type of tool tip 12, but for use in any bonding tool tip. Outer layers are labeled 71, 81, and 91, respectively, and cores are labeled 72, 82, and 92, respectively.

In one two-layered configuration, layers 71, 81 and 91 are highly doped semi-conductors and cores—72, 82 and 92—are insulators. In another two-layered configuration, layers 71, 81 and 91 are lightly doped semi-conductors and cores—72, 82 and 92—are conductors. No significance should be given to the relative thickness or scale of the portions of the layers. Layers may or may not have a uniform thickness.

Bonding tool tips with 10² to 10⁵ ohms of resistance and wedge bonding tools with a range of 10¹² to 10¹⁹ ohms of resistance for bonding electrical connections to bonding pads on electrical devices may be implemented through these various embodiments. The range of resistance needs to be lower as the electrostatic discharge (ESD) voltages get smaller to avoid damaging delicate electronic devices by any electrostatic discharge. A bonding tool tip or wedge bonding tool must conduct electricity at a rate sufficient to prevent charge buildup and stop all transient currents, but not at so high a rate as to trap voltage in the device being bonded. It is desirable for the bonding tool tip or wedge bonding tool to discharge as quickly as possible but to have less than 5 milliamps of currents. The tool tip or wedge bonding tool should also discharge or block any sudden surges of current that could damage the part being bonded.

Bonding tools with tip resistance can be manufactured through the use of mixing, molding, and sintering reactive powders; the use of hot pressing reactive powders; and through fusion casting.

Through the use of mixing, molding, and sintering reactive powders—for example, alumina, zirconia, iron oxide, or titanium oxide—fine particles (e.g., a half of a micron in size) of a desired composition are mixed with organic and inorganic solvents, dispersants, binders, and sintering aids. The binder and/or the sintering aids could be any of, any combination of, or all of magnesia, yttria, boron, carbon colloidal silica, alumina solvents, ethyl silicate, any phosphate, any rare earth metal oxide, or yttrium. Solvents, too, could be any of the aforementioned elements, compounds, or combination in addition to H₂O, for example.

The mixture is then molded into oversized wedges. The wedges are carefully dried and slowly heated to remove the binders and dispersants. In one embodiment, the wedges are heated to a temperature between 500-2500 degrees Celsius.

The wedges are then heated to a high enough temperature so that the individual particles sinter together into a solid structure with low porosity. In one embodiment, the wedges are heated to at least a temperature of 4000 degrees Celsius. The heat-treating atmosphere is chosen to facilitate the removal of the binder at a low temperature and to control the valence of the dopant atoms at the higher temperature and while cooling. After cooling, the wedges may be machined to achieve required tolerances.

The wedges may then be treated to produce a desired surface layer (e.g., 100 to 1000 Angstroms thick) by ion implementation, vapor deposition, chemical vapor deposition, physical deposition, electroplating deposition, neutron bombardment, or combinations of the above. The pieces may be subsequently heat treated in a controlled atmosphere (e.g., 2000 to 2500 degrees Celsius for 3 to 5 minutes) to produce desired layer properties through diffusion, re-crystallization, dopant activation, or valence changes of metallic ions.

Through the use of hot pressing reactive powders—like those disclosed above—fine particles of a desired composition are mixed with binders and sintering aids, like those disclosed above. The mixture is then pressed in a mold at a high enough temperature (e.g., 1000 to 4000 degrees Celsius) to cause consolidation and binding of the individual particles into a solid structure with low porosity (e.g., having grain size of less than half a micron in size). In one embodiment, the temperature is between 1000 and 2500 degrees Celsius. The hot pressing atmosphere is chosen to control the valence of the dopant atoms.

After cooling and removal from the hot press, the pieces may be machined to achieve required tolerances. The pieces may then be treated to produce a desired surface layer by ion implementation, vapor deposition, chemical vapor deposition, physical deposition, electo-plating deposition, neutron bombardment, or combinations of the above.

The pieces may subsequently be heat treated in a controlled atmosphere to produce desired layer properties through diffusion, re-crystallization, dopant activation, or valence changes of metallic ions.

Through fusion casting, metals of a desired composition are melted 1202 in a non-reactive crucible before being cast into an ingot. The ingot is then rolled extruded, drawn, pressed, heat-treated (e.g., at 1000 degrees Celsius or 500 degrees Celsius to 2500 degrees Celsius for one to two hours) in a suitable atmosphere, and chemically treated.

The rolling, extruding, drawing, and pressing steps shape the tip, while heat treatment and chemical treatment steps affect or impart mechanical and electrical properties such as hardness and resistivity.

The pieces may then be machined to achieve required tolerances. The metallic pieces may also be treated to produce a desired surface layer by vapor deposition, chemical vapor deposition, physical deposition, electroplating deposition, or combinations of the above.

The pieces may subsequently be heat-treated (e.g., 4000 degrees Celsius for three to four hours) in a controlled atmosphere to produce desired layer properties through diffusion, re-crystallization, dopant activation, or valence changes of metallic ions.

The present invention further provides that the layer used in the bonding process may be the following composition of matter; for example, a formula for dissipated ceramic comprising alumina (aluminum oxide) and zirconia (zirconium oxide) and other elements. This mixture is both somewhat electrically conductive and mechanically durable. The tip of a bonding tool will be coated with this material or it could be made completely out of this material. The shape of the tip may be as shown and described in earlier FIGS. 1 to 5.

The bonding tip and wedge tool of the present invention can be used for any number of different types of bonding including ultrasonic and thermal bonding.

While the present invention has been described with reference to exemplary embodiments, it will be understood by those skilled in the art that various changes may be made and equivalents may be substituted for elements thereof without departing from the true spirit and scope of the present invention. In addition, modifications may be made without departing from the essential teachings of the present invention.

What is claimed is:

1. A bonding tool, comprising:
a tube hole running a length of the bonding tool, the tube hole configured to accommodate a continuous feed of wire;
a tool tip comprising an exit hole, whereby the continuous feed of wire exits the bonding tool; and
a resistance material coating the tool tip, the resistance material having a resistance range of 10² to 10⁵ ohms, wherein the material has a resistance low enough to discharge a voltage in a device being bonded and high enough to avoid current flow large enough to damage the device being bonded.

2. The bonding tool of claim 1, further comprising a chamfer surface at the exit hole to accommodate a ball formed at the end of the continuous feed of wire.

3. The bonding tool of claim 1, wherein the discharge is at a rate of less than 5 milliamps of current.

4. The bonding tool of claim 1, wherein the tool is configured for use in an ultrasonic bonding machine for connecting leads on integrated circuit bonding pads.

5. The bonding tool of claim 1, wherein the resistance material comprises an extrinsic semi-conducting material, wherein the concentration and valence state of the dopant atoms produce the resistance range.

6. The bonding tool of claim 5, wherein the semi-conducting material comprises silicon carbide uniformly doped with boron.

7. The bonding tool of claim 1, wherein the resistance material comprises a doped semi-conductor formed on an insulating core.

8. The bonding tool of claim 7, wherein the insulating core comprises diamond and the doped semi-conductor comprises an outer surface of the diamond that is ion implanted with boron.

9. The bonding tool of claim 1, wherein the resistance material is a doped semi-conductor formed on a conducting core.

10. A wedge tool, comprising:
a tube hole running a length of the wedge tool, the tube hole configured to accommodate a feed of insulation wire;
an exit hole, whereby the feed of insulation wire exits the wedge tool; and
a resistance material coating the wedge tool, the resistance material having a resistance range of 10¹² to 10¹⁹ ohms, wherein the material has a resistance low enough to discharge a voltage in a device being bonded and high enough to avoid current flow large enough to damage the device being bonded.

11. The wedge tool of claim 10, wherein the tool is configured to capture and ultrasonically bond the insulated wire.

12. The wedge tool of claim 10, wherein the discharge is at a rate of less than 5 milliamps of current.

13. The wedge tool of claim 10, wherein the resistance material comprises an extrinsic semi-conducting material, wherein the concentration and valence state of the dopant atoms produce the resistance range.

14. The wedge tool of claim 13, wherein the semi-conducting material comprises silicon carbide uniformly doped with boron.

15. The wedge tool of claim 10, wherein the resistance material comprises a doped semi-conductor formed on an insulating core.

16. The wedge tool of claim 15, wherein the insulating core comprises diamond and the doped semi-conductor comprises an outer surface of the diamond that is ion implanted with boron.

17. The wedge tool of claim 10, wherein the resistance material is a doped semi-conductor formed on a conducting core.

18. An ultrasonic bonding method, comprising:
continuously running insulation wire through a tube hole in a bonding tool;
forming a ball at a chamfer, the ball formed from melting of the insulation wire;
bonding at least one lead on an integrated circuit device using the ball and a tool tip of the bonding tool, the tool tip having been coated with a resistive material, wherein contact of the tool tip with the integrated circuit device causes a resistive discharge of voltage without a current flow that damages the device being bonded, the resistive discharge having a resistance range of 10² to 10⁵ ohms.
